(19) United States
(12) Patent Application Publication
(10) Pub. No.: US 2007/0090796 A1
(43) Pub. Date: Apr. 26, 2007

(54) Power adapter for power tools

(76) Inventor: Waatani Norris, San Diego, CA (US)

Correspondence Address: Vista IP Law Group LLP, 2040 MAIN STREET, 9TH FLOOR, IRVINE, CA, 92614, US

(21) Appl. No.: 11/287,626

(22) Filed: Nov. 28, 2005

Related U.S. Application Data
(60) Provisional application No. 60/726,231, filed on Oct. 14, 2005.

(51) Int. Cl. H02J 7/00

(52) U.S. Cl. 320/114

(57) ABSTRACT

A power adapter for powering battery-operated (also referred to as “cordless”) power tools using electricity from a standard AC electrical outlet. Cordless power tools are typically powered by a battery cartridge which is removeably attached to the power tool. The battery cartridge includes a housing which contains the battery cells and electrical connections for electrically connecting the battery cartridge to the power tool. The power adapter of the present invention replaces, at least temporarily, the battery cartridge and comprises a housing which contains a transformer for converting the alternating (AC) electrical current to the same direct current (DC) electrical power provided by the battery cartridge. The power adapter further comprises electrical connections adapted to connect to the electrical connections of the cordless power tool. The power adapter housing has substantially the same overall size and shape as the battery cartridge which it replaces. The power adapter also has a power cord electrically connected to the input of the transformer and which extends from the housing and which can be plugged into a standard AC electrical power outlet.

In accordance with 35 U.S.C. Section 119(e), and any other applicable laws, this application claims the benefit of U.S. Provisional Application No. 60/726,231, filed Oct. 14, 2005. The contents of the aforementioned provisional application is incorporated by reference in its entirety as if set forth fully herein.

### FIELD OF THE INVENTION

The present invention relates generally to the field of power tools, and more particularly to an AC to DC power adapter (transformer and/or converter) for powering battery-operated power tools using a standard AC electrical outlet.

### BACKGROUND OF THE INVENTION

Numerous power tools utilize batteries as their primary power source and are commonly referred to as “cordless” because they do not require a cord for connection to an alternating current (AC) electrical outlet. Such power tools include drills, drivers, impact drivers/wrenches, circular saws, reciprocal saws, jig saws, lighting equipment, vacuums, and also many lawn & garden power tools such as sweepers, chainsaws, grass trimmers, hedge trimmers, lawn edgers, lawn mowers, pole pruners, pressure washers, shears. The battery-operated, or cordless, power tools have the advantage that they can be used where an AC outlet is inconvenient or even unavailable. Accordingly, cordless power tools are particularly advantageous on remote or outdoor jobsites and also in areas where electricity supplies are unreliable, such as in many foreign markets.

On the downside, battery-operated power tools have a limited amount of power available before the battery(ies) must be replaced or re-charged. Most cordless power tools use battery cartridges, not standard battery cells such as “C” or “D” cells that are sold in almost every market, hardware store, convenience store, etc. Instead, the battery cartridges are custom designed for use with a single manufacturer power tool or a line of tools (e.g. a single battery cartridge from Makita® may be designed for use in certain Makita drills and saws). Accordingly, the battery cartridges are relatively expensive and it is usually cost prohibitive for a user to have more than two or three batteries for any cordless power tool. Moreover, it typically takes much more time to charge the battery cartridge than the amount of time that the power tool can be operated on a single charge. Accordingly, it is not uncommon for a user to use up the charge on all of his/her battery cartridges and not have time to re-charge the battery cartridges in order to continue working. Thus, the user must either wait for a battery cartridge to charge up or switch to a corded (AC) power tool, if the user has such a tool. But this requires the user to purchase and have available at the work site an extra power tool, which may be an expensive and inconvenient proposition.

Therefore, a need exists for an adapter that allows a battery-operated power tool to be powered by standard AC electrical power. In addition, the adapter should be contained in substantially the same size and shape package as the battery cartridge so that the power tool has the same ergonomics with the adapter as it does with the battery cartridge, except for the power cord of the adapter.

### SUMMARY OF THE INVENTION

The present invention provides an AC to DC power adapter for powering battery-operated (also referred to as “cordless”) power tools using a standard AC electrical outlet. Cordless power tools typically use a battery cartridge which is removable from the power tool and rechargeable. The battery cartridge has a housing which contains the battery cells and electrical connections for electrically connecting the battery cartridge to the power tool. The power adapter of the present invention comprises a housing which contains a transformer for converting the AC electrical current to direct current (DC). In most cases, the transformer also converts the voltage available at the AC electrical outlet (generally 110 Volts or 220 Volts) to the typically lower voltage utilized by cordless power tools. (Sometimes the term “converter” is used to refer to electronics for converting the voltage of an electrical power source to a different voltage. However, as used herein, the term “transformer” is used to refer to an electronic device which can convert AC to DC and/or can convert the voltage.) For example, typical voltages supplied by the battery cartridges of power tools are 24 Volt, 18 Volts, 14.4 Volts, 12 Volts, 9.6 Volts, 7.2 Volts, and 4.8 Volts. Still, it is contemplated by the present invention that the power adapter can be designed to operate at any of the voltages utilized by cordless power tools.

The power adapter further comprises electrical connections adapted to connect to the electrical connections of the cordless power tool which normally couple to the electrical connections of the battery cartridge. Accordingly, the power adapter is contained in a housing which is configured to couple to the power tool in substantially the same or similar manner as the battery cartridge which the adapter replaces. In a further innovative aspect of the present invention, the power adapter housing may also have substantially the same overall size and shape as the battery cartridge which it replaces. In this way, the power adapter maintains substantially the same ergonomics such as balance and size as the cordless power tool with the battery cartridge. The power adapter also has a power cord extending from the housing which can be plugged into a standard AC electrical power outlet.

The operation of the power adapter of the present invention is then straightforward. The battery cartridge of the cordless power tool is removed. The power adapter is attached to the power tool. Various cordless power tools have varying configurations for receiving and retaining their battery cartridges. In some cases, the battery cartridge is inserted into a slot or receptacle while in other cases the battery cartridge simply snaps onto the power tool. Therefore, the use of the terms “on” or “in” used with respect to the relationship of elements of the present invention includes both “on” or “in.” The power cord of the power adapter is plugged into a standard AC electrical power outlet. The power tool is now ready for use and is powered by electricity supplied from a standard AC power outlet, rather than the battery cartridge.

The foregoing, together with features and advantages of the present invention, will become more apparent when referring to the following detailed description, accompanying drawings and claims.

### BRIEF DESCRIPTION OF THE DRAWINGS

FIG. 1 is a perspective view of an exemplary cordless power tool with the battery cartridge installed.

FIG. 2 is a perspective view of the power tool of FIG. 1 with the battery cartridge removed.

FIG. 3 is a perspective view of the power tool of FIG. 1 with a power adapter according to the present invention installed.

FIG. 4 is a perspective view of the power tool of FIG. 1 with a power adapter according to the present invention removed.

### DETAILED DESCRIPTION OF THE INVENTION

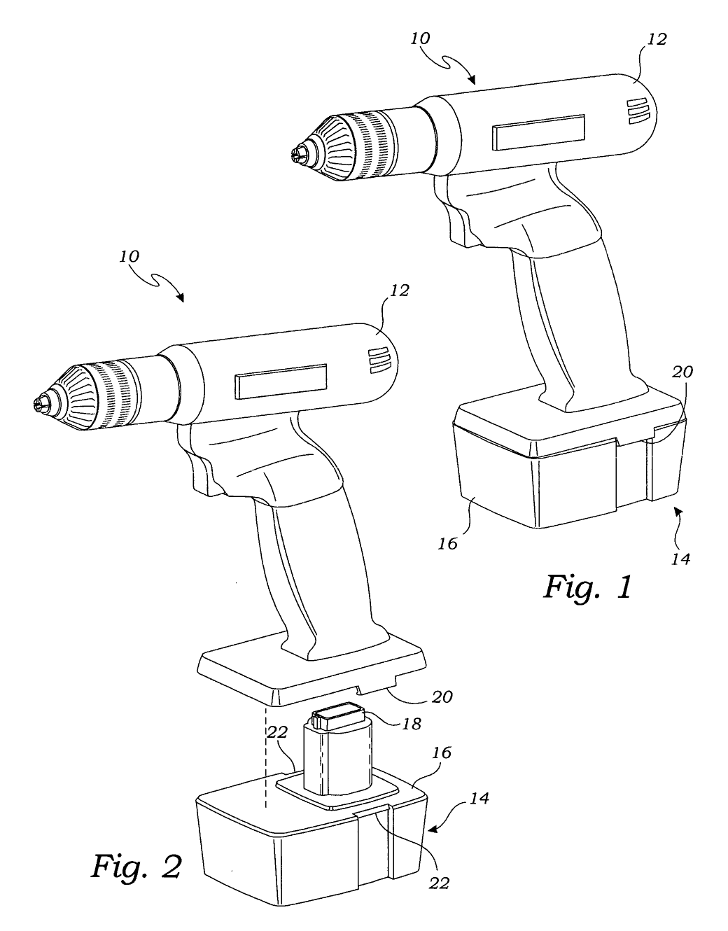

Turning to FIG. 1 and FIG. 2, an exemplary cordless power tool 10, in this case a cordless power drill, is shown. It is should be understood that the cordless power tool can be any type of power tool, including without limitation all of the power tools described above.

The power drill 10 includes a main body 12 and a battery cartridge 14. The battery cartridge 14 is removable from the main body 12 as shown in FIG. 2. The battery cartridge 14 includes a housing 16 and a battery contact 18. The battery contact 18 comprises at least two electrical connections which function as the positive and negative terminals of the battery cartridge. The battery electrical contact 18 couples to a power tool contact (not shown) provided in the main body 12 when the battery cartridge 14 is installed on the main body 12.

In the exemplary power tool of FIGS. 1 and 2, the battery cartridge 14 is retained on the main body 12 by a pair of releasable clasps 18 which releasably engage mating retaining clips 22. However, it should be understood that any other suitable engagement feature may be used to retain the battery cartridge 14 to the main body 12, such as latches, detents, clips, snap-fit, etc.

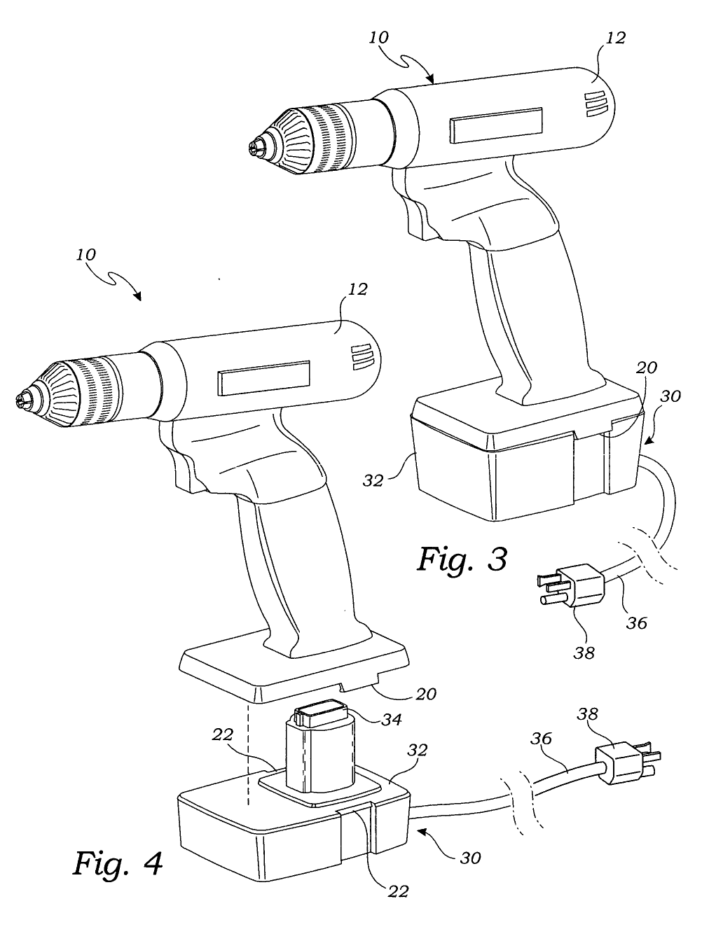

Turning now to FIGS. 3 and 4, the power adapter 30 of the present invention is shown both installed and removed from the same power tool 10 having a battery cartridge 14 as shown in FIGS. 1 and 2. Accordingly, the power adapter 30 has a housing 32 which is substantially the same size and shape as the housing 16 of the battery cartridge 14.

Inside the housing 30, and not shown in the figures, is an electrical power transformer for converting the AC electrical current to direct current, e.g. AC to DC. The transformer includes a rectifier as well-known in the art for converting AC to DC. The transformer may also include a “smoothing circuit,” as it is known, for producing steady DC power from the rectified AC supply. Such circuits are known by those ordinarily skilled in the art so it is unnecessary to provide a detailed description. The transformer also includes electronics to convert the voltage from the higher voltage typically available at an AC electrical outlet (generally 110 Volts or 220 Volts) to the lower voltage utilized by cordless power tools. As explained above, typical voltages supplied by the battery cartridges of power tools are 24 Volt, 18 Volts, 14.4 Volts, 12 Volts, 9.6 Volts, 7.2 Volts, and 4.8 Volts. The electronics for converting the voltage are also well-known in the art and are not explained in detail herein. The transformer is entirely contained in the housing 32. A power cord 36 is electrically connected to the input of the transformer and extends out of the housing 32. The distal end of the power cord 36 has a standard electrical plug 38 which can be plugged into a standard AC electrical outlet.

The power adapter 30 comprises an adapter electrical contact 34 which is substantially identical to the battery electrical contact 18 described above. The adapter electrical contact 18 is electrically connected to the output of the transformer. The power adapter 30 also includes the retaining clips 22 for retaining the power adapter 30 to the clasps 18 of the power tool main body 12. The engagement feature used on the power adapter 30 is preferably the same as the engagement feature used on the battery cartridge 14 that it replaces.

While the present invention has been fully described above with particularity and detail in connection with what is presently deemed to be the invention, it will be apparent to those of ordinary skill in the art that many modifications thereof may be made without departing from the principles and concepts set forth herein. Hence, the proper scope of the present invention should be determined only by the broadest interpretation of the appended claims so as to encompass all such modifications and equivalents.

What is claimed is:

1. A power adapter for use with a battery operated power tool having a battery cartridge which attaches to a main body of the power tool, said battery cartridge including a battery housing and a battery electrical contact for electrically connecting the battery cartridge to the power tool, the power adapter comprising:
an adapter housing configured for attachment to said main body of said power tool, said attachment being substantially similar to the attachment of said battery cartridge to said main body of said power tool;
a transformer entirely contained within said housing, said transformer having an electrical input and an electrical output, said transformer adapted to convert standard AC power from an electrical power outlet to substantially the same DC power provided by said battery cartridge; and
an adapter electrical contact electrically connected to said transformer, said adapter electrical contact adapted for electrically connecting to said power tool.

2. The adapter of claim 1 wherein said adapter housing is substantially identical in size and shape as said battery housing.

3. The adapter of claim 1 wherein said transformer converts standard AC power to DC power and also converts the voltage of said standard AC power to a lower voltage which is substantially the same as the voltage provided by said battery cartridge.

4. The adapter of claim 2 wherein said transformer converts standard AC power to DC power and also converts the voltage of said standard AC power to a lower voltage which is substantially the same as the voltage provided by said battery cartridge.

5. The adapter of claim 1 wherein said adapter further comprises an engagement device for retaining said adapter to said power tool.

6. The adapter of claim 1 wherein said engagement device is substantially identical to an engagement device on said battery cartridge.

7. The adapter of claim 2 wherein said adapter further comprises an engagement device for retaining said adapter to said power tool.

8. The adapter of claim 3 wherein said adapter further comprises an engagement device for retaining said adapter to said power tool.
